(19) United States
(12) Patent Application Publication
(10) Pub. No.: US 2008/0301002 A1
(43) Pub. Date: Dec. 4, 2008

(54) Method of providing interactive financial services on a multi-lingual single destination internet platform

(76) Inventors: Alan Chokov, Manasquan, NJ (US); Li Ma, Monmouth Junction, NJ (US)

Correspondence Address: CLIFFORD G. FRAYNE, 136 DRUM POINT RD, SUITE 7A, BRICK, NJ, 08723, US

(21) Appl. No.: 12/154,793

(22) Filed: May 27, 2008

Related U.S. Application Data
(60) Provisional application No. 60/932,049, filed on May 29, 2007.

(51) Int. Cl. G06Q 40/00; G06Q 30/00

(52) U.S. Cl. 705/26; 705/36 R

(57) ABSTRACT

The financial portal and search engine micro markets consumer specific finance inquires and needs to product specific financial service providers and then allows these service providers to display their expertise and compete on the cost of the service or product required by the consumer interactively so that the consumer is simultaneously aware of all financial providers offering the specific products or services required by the consumer and the service providers can communicate to the consumer simultaneously, the cost of such products and/or services. These services are self-managed by the service providers through their Personal Management Account on the site, which allows the provider to choose what he wants to present; in what format, duration and market exposure.

### RELATED APPLICATIONS

Applicant claims the benefit of provisional application Ser. No. 60/932,049, filed May 29, 2007.

### BACKGROUND OF THE INVENTION

1. Field of the Invention

The present invention relates to an interactive financial portal and search engine promoting financial literacy, financial service providers (Sponsors), and their product services on a multi-lingual, single destination internet platform for consumers.

2. Description of the Prior Art

Financial products and services are primarily marketed to consumers by their provider in multimedia advertisements, such as direct mailings, print advertising, radio advertising and television advertising, as well as internet websites. The individual provider being naturally biased to advertise and promote his products and services does so and thus requires the consumers seeking financial products or services to search the multimedia advertising for comparisons or for a specific product or service which may not be provided by all financial providers.

Prior to the development and integration of the internet, this would be a time consuming task requiring much reading, telephone inquiry and face to face meetings in order to find the particular product, service or combination of product and service, which the consumer sought.

The development of the internet sped up the process, but still required the consumer to go to different sites in order to make comparisons of the products or services sought and the cost of same. There has long been a need for a method or provider whereby the consumer can input consumer specific finance inquiries and needs to a financial portal and search engine and be connected with all of those financial service providers subscribing to the financial portal and search engine that can provide or respond to the consumer specific finance inquiry or need in real-time. In effect, the financial portal and search engine micro markets consumer specific finance inquires and needs to product specific financial service providers and then allows these service providers to display their expertise and compete on the cost of the service or product required by the consumer interactively so that the consumer is simultaneously aware of all financial providers offering the specific products or services required by the consumer and the service providers can communicate to the consumer simultaneously, the cost of such products and/or services. These services are self-managed by the service providers through their Personal Management Account on the site, which allows the provider to choose what he wants to present; in what format, duration and market exposure.

### OBJECTS OF THE INVENTION

An object of the present invention is to provide a novel interactive financial portal and search engine promoting financial service providers, their products and services, as well as financial literacy, on a multi-lingual, single destination internet platform.

A still further object of the present invention is to provide a novel interactive financial portal and search engine which allows consumers to make consumer specific finance inquiries regarding needs for products or specific financial services and allows subscribing financial service providers to identify themselves vis-à-vis the consumer specific inquiry and to bid for the right to provide the products and/or services.

A still further object of the present invention is to provide for a novel interactive financial portal and search engine promoting financial service providers, products and services on a multi-lingual, single destination internet platform wherein the financial service providers can compete for consumer business on line, so that consumer inquirers can comparatively shop for the investments, services, rates, fees and products which they desire, and to make instantaneous comparison between alternative financial service providers.

A still further object of the present invention is to allow a novel interactive financial portal and search engine which allows the financial service provider to self-manage their account, acting in concert with the ability to submit to the multiple components of the site directly from their personal computer in real time, thereby providing immediate pertinent information to the consumer.

A still further object of the present invention is to allow a novel interactive financial portal and search engine which allows the user to access a cross-section of comparative information relative to 50,000 keywords from all components of the site submitted by subscribing financial service providers.

A still further object of the present invention is to provide a novel interactive financial portal and search engine which allows consumers in need of language translation assistance to search financial service providers by criteria search, which includes languages spoken.

### SUMMARY OF THE INVENTION

The financial portal and search engine micro markets consumer specific finance inquires and needs to product specific financial service providers and then allows these service providers to display their expertise and compete on the cost of the service or product required by the consumer interactively so that the consumer is simultaneously aware of all financial providers offering the specific products or services required by the consumer and the service providers can communicate to the consumer simultaneously, the cost of such products and/or services. These services are self-managed by the service providers through their Personal Management Account on the site, which allows the provider to choose what he wants to present; in what format, duration and market exposure.

### BRIEF DESCRIPTION OF THE DRAWINGS

These and other objects of the present invention will become apparent, particularly when taken in light of the following illustrations wherein:

FIG. 1 is a diagram of the system architecture and hardware components of the system; and

FIG. 2 is a block diagram of the software structure of the system.

### DETAILED DESCRIPTION OF THE INVENTION

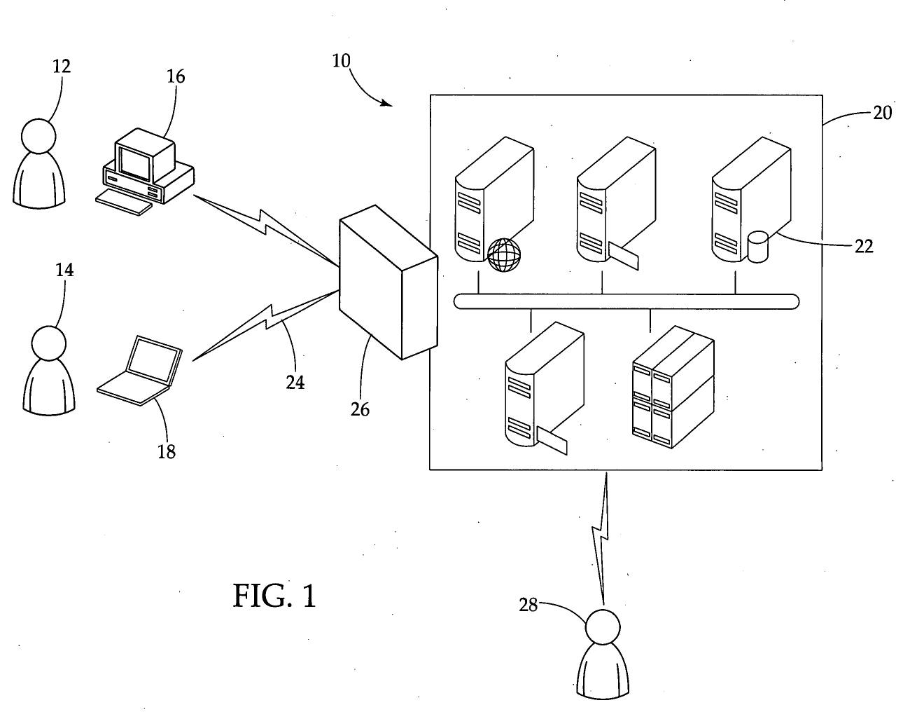

FIG. 1 is a schematic of the network structure 10. Each client 12 and each provider 14 would be capable of accessing the internet via their own computers 16 and 18 respectively. The system site 20 would consist of a server cluster 22, access to which will be provided by one or more T3 lines 24. These T3 lines 24 would be connected to the server cluster via a secured firewall 26 to protect security of the information handled by the server cluster. A system administrator 28 would have access to and oversee the server cluster 22.

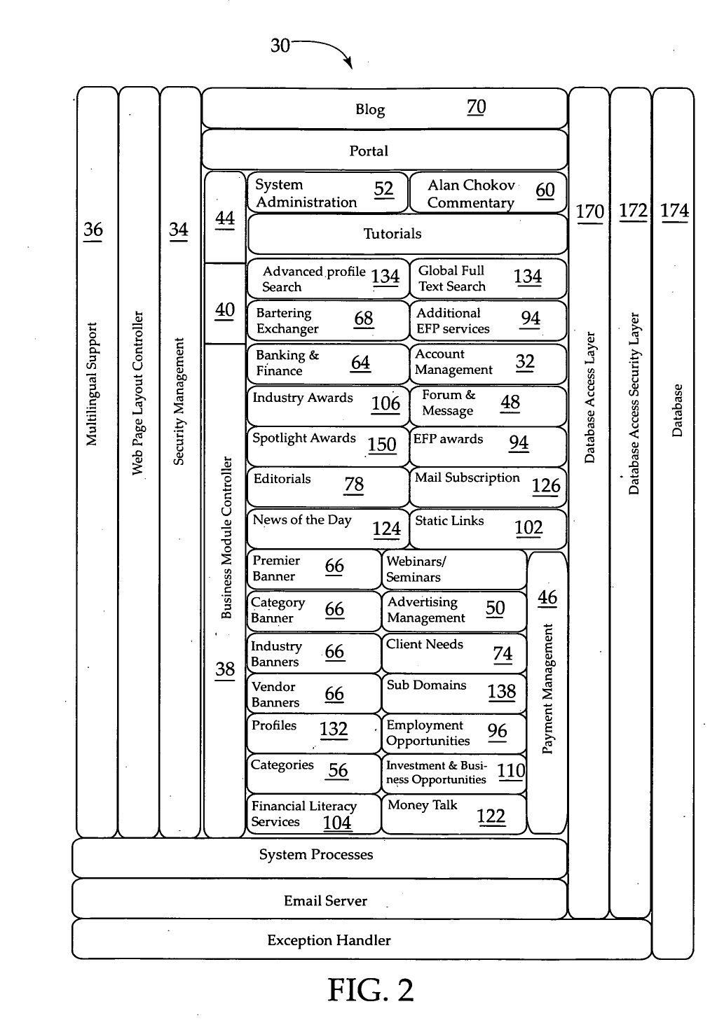

FIG. 2 illustrates software components running on the server cluster and application servers. Different software server components will be running on the servers to provide real time service. The relationship 30 of the software components are shown in FIG. 2, and a short description of each follows.

The account management component 32 would interface with all financial service providers 14 on the site. All providers 14 would require at least one login account depending upon their size, their branches, their management hierarchies and their service provided. The clients or users 12 of the service can browse all the provided information without a login account, but in the event that a user/client 12 requires advanced features or communication with the providers 14, then the account management component 32 can create a user/client account. The account management component 32 in cooperation with the security management component 34 described hereafter, insures that each account can only access information to which they are allowed.

The security management component 34 is a centralized point in the system to manage all security related issues including account authorization and account authentication. The security management component 34 will check to determine if certain data or operation is assessable for a given account or beyond the authority of a particular account and similarly, block access.

The multilingual support component 36 allows the user/client 12 to choose their favorite language when accessing the website. The multilingual support component 36 will be able to detect a user's preference and render the web pages in different languages in real time. Besides utilized as a web interface for the user/client, the multilingual support component 36 provides user/clients 12 with a choice of language as one of their search criteria. This type of search is only for retrieving the multilingual information from the provider's profile.

All content submitted to the site by providers 14 can be submitted by them in their language of preference. The site supports 170 languages, which is over 99% of the World's spoken languages.

A rich media engine component will permit those user/clients 12 with broadband cable or DSL to take advantage of high speed internet connection for rich media content, including, but not limited to, video, audio, flash and animated images.

The business module 38 is a dispatcher to a router for requests of users and providers to a specific component below it.

The advanced profile search allows the user/clients to post a request with certain specifications to the site and the component will automatically find and identify providers 14 that match their requests best. Once a match is found, a user/client 12 can view the matched providers 14 in a list which can be sorted by name, specialty, location, languages, rating, etc.; and click on each one to see more details. In addition to this service, In the Forum component 42, when a user/client 12 posts a question that is related to the category chosen, those providers 14 will be contacted when if it matches their profile to allow the provider 14 to contact the user/client 12, if the client wishes to be contacted.

The query/reporting engine component 44 incorporated in the business module controller 38 will host the categories, multiple derivatives and interpretations, as well as the identity of the financial service providers 14. The query component will allow the user/client 12 to search in categories, location specialties, ratings, keywords, languages and the like. The search result can be saved for future reference and an alert can even be sent to a user/client 12 when a new provider 14 matches the criteria.

The financial service providers 14 will be able to query on registered customers based on their needs. Normally a match of providers will be listed and notified automatically and in some instances, the providers will be able to find their request by query and submit their offer to the client on line.

The payment module component 46 will take care of collecting payment from the providers, advertisers, etc. It will also be able to provide escrowed service accounts.

The Forum component 48 will create and run public forums to allow all registered user/clients 12 and providers 14 to post public messages to categorize topics and exchange ideas.

The advertising management component 50 will provide different levels of advertising services based on locations in the page, size of area, and duration.

The system administration module component 52 allows the system administrator 28 to view all aspects of the system and to manage all back issues such as account auditing, management advertising, database backup, etc.

Financial service providers 14 can determine what components of the site they wish to contribute to in promoting their products and services to consumers.

The categories component 56 organizes the financial service providers by categories. Each provider can fit into multiple categories based upon the services which they offer.

The Affiliates component provides affiliate participation through reciprocal links 102.

The Alan Chokov Commentary component 60 provides a platform for opinions; ideas and editorials and interactive options presented by Alan Chokov.

An Ask The Experts component in Forum 48 provides a platform for question and answer exchanges for participating financial service providers and registered users.

A Banking & Finance component 64 provides a platform for Sponsor's submissions on Banking and Finance related issues.

A Banners component, including premier banner, category banners, industry banner and vendor banner 66 provides Sponsors the opportunity to purchase advertisement locations throughout our site to promote their expertise, services and products.

A Bartering Exchange component 68 provides a platform for Registered Users and Sponsors to submit bartering opportunities. Communication between the bartering parties will be directly based on the contact information provided by them.

A Blog component 70 provides Sponsor commentaries and/or news on their preferred subject in a “journal” style; displayed in a reverse chronological order. Readers will be able to submit comments in an interactive format.

A Charitable Events component provides a calendar of charitable events, which is opened to all charities.

A Client Needs component 74 provides Sponsors and Registered Users a platform for investment and business demands by requesting products, services, funding and other related interests that can be responded to by all Sponsors and Registered Users.

The Client Needs component provides Registered Users the platform to place their financial requirement needs for sponsors to respond to.

The Editorials component 78 provides the platform for Sponsors to express their opinions in this publication of articles.

The following subcomponents are found within the account management component 32:

The eFP Accounts component is a requirement for anyone that wishes to submit in any format; will have to establish an eFinancePortal.com account. There are five account selections to choose from:

1. The User Account component is for those who would like prefer to submit text under the Consumer Needs; Forum 48 and Bartering Exchange 68 components. It also provides the option to establish contact with their preferred financial representatives.

2. The Individual Provider component is for the Financial Service Provider, which can be an individual or entity. This account gives full access to all components offered by the site.

3. The Company Provider component is for Financial Service Companies, which include all companies providing services and support to financial industries. Attaching an FSP profile to an FSC account is also available.

4. The Vendor Account component is for companies which provide products and services utilized by Financial Service Providers, Financial and/or Educational industries, associations and consumers. This account gives full access to all components offered by the site.

5. The Non-Profit Organization Account component is for entities with non-profit tax status.

6. The NJ Government Account component are elected or appointed officials who support Financial Literacy.

The eFP Awards and Announcement component 92 is selected by the efinanceportal.com selection committee for placement on the Home Page. Sponsors and others can also submit their application to be entered under this service.

The Business and Technologies Services component 94 provides access to a wide range of additional internet, marketing, development and institutional related services provided by eFinancePortal.com and its affiliates.

The Employment Opportunities by Sponsors component 96 provides a platform for job offering submitted by Sponsors.

The Featured By component 98 is reserved for those individuals and entities who endorse efinanceportal.com.

The Environmental Events component 100 provides a calendar of environmental events, which is opened to all organizations involved in Environmental issues.

The Eternal Links component 102 provides a way to redirect links to Sponsor's websites not located on efinanceportal.com, such as affiliates, newsletters, etc.

The Financial Literacy Services component 104 provides a platform for links supporting Financial Literacy by Sponsors offering programs, assistance and supportive components.

The Forum component 48 groups the “Industry Q&A”, “Internal Revenue Service Q&A”, “Client/Consumer Needs” and “Bartering Exchange” in the “My Account” management. All Users have the opportunity to submit questions (and answers) regarding financial services. Sponsors will have the added bonus of receiving an email (if option is chosen) to respond to the question as it relates to their category and profile. This lead generation provides the opportunity for the sponsors to respond to the question, providing additional market exposure. “Q&A” can be submitted by industry or category.

The Industry Awards component 106 provides for awards and announcements for those who have received recognition in their respective industries.

The Industry Q&A component provides typical questions and answers concerning each of the sites Industry selection. The Internal Revenue Service has its own link from the homepage where Users and Sponsors can find help concerning this industry. This component is also included under the “Ask The Experts” and the Forum 48.

The Investment and Business Opportunities component 110 provides Sponsors with a presentation of opportunities for investment and/or participation by product, service, funding and other related possibilities in various forms for the Users.

The Investment Tools component of business opportunities component 116 provides Investment calculators analyzing investment options.

An IRS Q&A forum component provides typical questions and answers, regulations and comments provided through IRS publications.

A Language Options component provides the User with the option of viewing any text that has been translated by the Sponsors in their language of choice.

The Literacy Volunteers component provides a platform for those sponsors who can contribute their time and resources to educate the citizens of New Jersey.

A Money Talk component 122 provides a personal platform for experts in the industry of choice.

A News of the Day component 124 provides current articles related to any of the selected industries on the site. The new submission will rotate on the homepage and all articles will be accessible in the “More” option.

A Newsletters component 126 describes in a brief paragraph the type of newsletter Sponsor's are offering with an optional picture and the external link to access the newsletter.

A NJ Government Link provides a platform for all Users to view elected and appointed political figures who actively support financial literacy.

The New Jersey Government News and Events platform is used to post New Jersey Government News and Events.

The Profile component 132 is the Sponsor identification “card”. All Sponsor submissions are linked to this profile.

The Search Types component 134 provides six unique search capabilities; locating Financial Service Providers by name; by language spoken; by an advanced search; by companies; by category (alphabetically) and through a general search.

A Spotlight Awards component 150 features those individuals and companies that have received awards and announcements of merit in their respective fields.

The Sub-Domains component 138 provides the opportunity of a direct URL to the Sponsor's profile page on the site. This identifies the Sponsor's affiliation to eFinanceportal.com and a category of choice if available.

A Tutorial component 135 for Financial Service Providers, Financial Service Companies, Vendors, NJ Government and non-profit organizations are indexed to assist Sponsors on how they can take advantage of all of the features of the site. Pop-up versions are also available on the components throughout the site.

A Tutorials for Users component 135 provides an Index of uses and procedures to benefit from all of the site's components.

A Webinars/Seminars and Commercials component 144 provides participants with the opportunity to submit their seminars pre-taped online hosted by our website: External Seminar which is hosted by an outside website separated from the system and/or the External Physical Seminar which is allowing the providers to post information about a seminar happening in a “physical” location such as hotel, conferences, etc.

In operation, a provider 14 would access the site through the internet and be directed through the access security filter 34 to account management component 32. Provider 14 would then be provided with an identity and log in password so as to permit the provider 14 to download the particular data which the provider wishes to provide to the website. This data is transferred through the database access layer 170, database security layer 172, and stored in the database 174. The provider may also wish to provide certain advertising on the web site which would be set up through the accountant management component 32 and then be managed by the payment management component 56. Once the provider has been properly identified and has obtained his log in password, the provider 14 can update and modify his particular data at his discretion. The advance profile search matching engine component 40, the query/reporting engine component 44, and the search types component 134 of the business module controller 38 have access to the database in order to respond to client/user inquiries.

The client user 12 may be a read only client/user 12 in that the read only client/user does not wish to make specific inquiries, participate in forums, or interact with the website. The read only user/client 12 enters the website through the multilingual translator 36, choosing the language of choice. The read only user/client would proffer a question or query of a general nature, such as information on 401K plans. The advance profile search matching engine 40 in cooperation with the query reporting engine component 44 and search type component 134 would search the database and identify to the read only user/client 12 information relative to the general inquiry which the read only user/client 12 can then read or scan.

The second type of user/client 12 is the interactive user/client who logs on to the website in the same manner, but proceeds to the account management component 32 and obtains an identity, log in password, and the like. The interactive user/client 12 is allowed to make specific inquiries via the forum component 48. The interactive user/client 12 can pose questions of a specific nature which would be answered specifically by a provider having knowledge of the particular query. The interactive user/client 12 could ask a specific question of a specific provider or a specific question to which multiple providers may respond.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

We claim:

1. A method for permitting a consumer seeking financial services or financial products to inquire of a data base of financial services and financial goods providers, the method comprising:
establishing a system site having a plurality of service clusters accessed by a plurality of communication lines and overseen by a system administrator; allowing financial service providers and financial good providers to establish accounts on said data base advertising their goods, services and costs associated with their products;
allowing financial service providers to update their goods, services and costs through an administrative manager of said data base through a login system;
allowing consumers to make inquiry of the data base with respect to the availability of certain financial goods, services, and costs;
displaying in response to said inquiry relevant services, goods, and cost of said financial service providers having relevant information to said inquiries;
allowing consumers to study the displayed responses and relevant information of said financial service providers; and
allowing consumers to contact financial service providers to consummate transaction regarding said relevant goods, services or costs.

2. The method in accordance with claim 1 wherein said financial service providers are established with login accounts via an account administrator and security management system providing for authorization and authentication to allow said financial service providers to establish their relevant data bases and to update their relevant data bases as needed.

3. The method in accordance with claim 1 wherein said financial service providers are allowed to submit information to said data base in a language of preference, said system accommodating multilingual inquiries.

4. The method in accordance with claim 1 wherein said consumer may inquire and browse said data base with no requirement of a consumer login account, said consumer may establish a consumer login account in order to allow said consumer to contact said financial service provider and consummate a transaction.

5. The method in accordance with claim 1 wherein a plurality of business modules within said system site allows said financial service provider to establish multiple sites within said system for the advertisement and establishment of information regarding the financial services, financial goods, and financial costs of said financial service provider, said business modules routing said consumer inquiry to said relevant data established by said financial service provider.
